(19) United States
(12) Patent Application Publication
(10) Pub. No.: US 2014/0263693 A1
(43) Pub. Date: Sep. 18, 2014

(54) SYSTEM AND METHOD FOR PROVIDING A MICRON-SCALE CONTINUOUS LIQUID JET

(71) Applicant: ARIZONA BOARD OF REGENTS, a body corporate of the state of Arizona, acting for and on behalf, Scottsdale, AZ (US)

(72) Inventors: R. Bruce Doak, Tempe, AZ (US); John Spence, Tempe, AZ (US); Uwe Weierstall, Phoenix, AZ (US)

(73) Assignee: ARIZONA BOARD OF REGENTS, a body corporate of the state of Arizona, acting for and on behalf, Scottsdale, AZ (US)

(21) Appl. No.: 14/354,177

(22) PCT Filed: Nov. 19, 2012
(86) PCT No.: PCT/US2012/065788

§ 371 Date: Apr. 25, 2014

Related U.S. Application Data
(60) Provisional application No. 61/561,568, filed on Nov. 18, 2011.

(51) Int. Cl. B05B 9/04; B05D 1/32; B05D 1/00; B05B 1/02; B29C 39/02

(52) U.S. Cl. CPC B05B 9/04; B05B 1/02; B29C 39/02; B05D 1/005; B05D 1/32
USPC 239/1; 239/589; 239/373; 264/447

(57) ABSTRACT

A nozzle for producing a liquid jet a fluid, methods using the nozzle, and an injector comprising the nozzle of the invention for providing the liquid jet of a fluid to a vacuum system are described.

### CROSS-REFERENCE TO RELATED APPLICATIONS

This application claims the benefit of the filing date of U.S. Provisional Patent Application Ser. No. 61/561,568, filed Nov. 18, 2011, which is hereby incorporated by reference in its entirety.

### STATEMENT OF GOVERNMENT INTEREST

This invention was made with government support under Grant numbers 0919195 and 0555845 awarded by the National Science Foundation. The government has certain rights in the invention.

### FIELD OF THE INVENTION

The present disclosure relates to methods and devices for forming micron sized continuous liquid streams.

### BACKGROUND OF THE INVENTION

Analysis and manipulation of particles, such as proteins or other biological molecules, often requires introducing or injecting the particle into vacuum, where the particle must maintain its native conformation. Examples of particle manipulation or analysis that may require particle injection into vacuum include molecular structure determination, spectroscopy, particle deposition onto a substrate (to produce, for example, sensor arrays), nanoscale free-form fabrication, formation of novel low temperature forms of particle-containing complexes, bombardment of particles by laser light, x-ray radiation, neutrons, or other energetic beams; controlling or promoting directed, free-space chemical reactions, possibly with nanoscale spatial resolution; and separating, analyzing, or purifying these particles.

Prior devices for injecting these media into a vacuum included injecting a liquid surrounded by a pressurized gas flow through an aperture or channel and into a vacuum. However, these devices provided a series of liquid droplets. However, for many technological and scientific applications, the ability to form an accurately aligned microscopic continuous liquid jet is of great interest.

### SUMMARY OF THE INVENTION

In a first aspect, the invention provides a nozzle assembly comprising, (a) a housing, wherein a distal end of the housing defines an outlet channel, (b) a capillary disposed within the housing, wherein a distal end of the capillary is optionally tapered, and (c) at least one bore defined by the capillary, wherein the at least one bore defines a capillary outlet at the distal end of the capillary, and wherein the capillary outlet is located outside the outlet channel.

In a second aspect, the invention discloses a system for producing a continuous liquid jet comprising (a) a capillary having a bore and a capillary outlet, (b) a liquid reservoir coupled to the bore, and (c) a gas pressure source coupled to the liquid reservoir.

In a third aspect, the invention discloses a method for providing a continuous stream of high-viscosity liquid comprising the steps of: (a) providing a nozzle assembly according to the first aspect of the invention, wherein the capillary outlet protrudes from the housing, (b) injecting a first fluid into the proximal end of the housing, (c) injecting a second fluid into the proximal end of the capillary, (d) creating a gas back pressure on the second fluid, (e) the second fluid exiting the capillary outlet, and (e) the first fluid acting upon the second fluid to create a liquid jet that flows through the outlet channel.

In a fourth aspect, the invention provides a nozzle assembly comprising, (a) a housing, wherein the housing defines a cavity enclosed on all sides with an inlet opening at a proximal end and a de Laval Nozzle at a distal end, wherein the de Laval Nozzle defines a converging-diverging channel, and wherein a housing outlet is defined within the de Laval Nozzle at the point where the converging-diverging channel is constricted, (b) a capillary disposed within the cavity of the housing such that there is a coaxial space maintained between the capillary and the housing, wherein a distal end of the capillary tube is optionally tapered, (c) at least one bore defined by the capillary, wherein a proximal end of the at least one bore defines a capillary inlet and a distal end of the at least one bore defines a capillary outlet, wherein the capillary outlet does not extend beyond the housing outlet, and (d) wherein the housing further defines a first propelling channel and a second propelling channel, wherein the first and second propelling channels are each disposed substantially perpendicular to the coaxial space and are in fluid communication with the coaxial space. In one embodiment of the fourth aspect, the invention further provides a first switching channel defined in the housing on a first side of a diverging section of the converging-diverging channel and a second switching channel defined in the housing on the second side of the diverging section of the converging-diverging channel, wherein the first and second switching channels are each in fluid communication with the diverging section of the converging-diverging channel.

In a fifth aspect, the invention provides a method for producing a liquid jet comprising (a) providing a nozzle assembly according to the fourth aspect of the invention, (b) injecting a first fluid into the first and the second propelling channels, and (c) injecting a second fluid into the capillary inlet. In one embodiment, the foregoing method further comprises operating at subsonic flow by maintaining an upstream-to-downstream pressure ratio in a converging-diverging channel in the range of about 1.03 to about 1.89. In another embodiment, the method further comprises (a) producing a liquid jet following a boundary layer of a first side of a diverging section of a converging-diverging channel, (b) injecting a first puff of air into a first switching channel, and (c) in response to the first puff of air, switching the liquid jet to a boundary layer of a second side of the diverging section of the converging-diverging channel. In an additional embodiment, the method further comprises (a) injecting a second puff of air into a second switching channel and (b) in response to the second puff of air, switching the liquid jet to the boundary layer of the first side of the diverging section of the converging-diverging channel. In still another embodiment, the method further comprises (a) operating the diverging section of the converging-diverging channel under vacuum and (b) in response to operating under vacuum, producing a liquid jet substantially centered between the first side and the second side of the diverging section of the converging-diverging channel.

In an sixth aspect, the invention provides a method for manufacturing the housing of the nozzle assembly of the fourth aspect, comprising, (a) soft-baking photoresist that is spin-coated in a desired pattern on a silicon wafer, (b) exposing the photoresist to UV light through a photomask, (c) chemically developing the photoresist, (d) hard-baking the photoresist to form a negative stamp, (e) pouring uncured poly(dimethylsiloxane) into the negative stamp to create a layer defining a cavity and a plurality of microchannels, and (f) fixing the layer between a top slab and a bottom slab of poly(methyl methacrylate).

A continuous liquid stream has many advantages. For example, microscopic lipidic cubic phase (LCP) streams can be extruded at low volumetric flow rates that are well suited to the 120 Hz pulse rates of current hard-x-ray free-electron lasers: The low flow rate allows the LCP stream to be advanced between x-ray pulses by only the exact distance needed to expose fresh target material. Consequently little sample material is wasted and only a minimal amount of the LCP protein sample is needed. Since many membrane proteins are available only in quite limited quantities, this is a major experimental advantage.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts.

### BRIEF DESCRIPTION OF THE DRAWINGS

FIG. 1A is a cross-sectional view of a nozzle according to an embodiment of the invention.

FIG. 1B is a perspective view of a nozzle according to an embodiment of the invention.

FIG. 1C is a perspective view of a nozzle according to an embodiment of the invention.

FIG. 2A is a perspective view of a nozzle according to an embodiment of the invention.

FIG. 2B is a cross-sectional view of a nozzle according to an embodiment of the invention.

FIG. 3A is a perspective view of a nozzle according to an embodiment of the invention.

FIG. 3B is a cross-sectional view of a nozzle according to an embodiment of the invention.

FIG. 4 illustrates a method according to an embodiment of the invention.

FIG. 5 is a view of a nozzle producing a continuous liquid jet according to an embodiment of the invention.

FIG. 6 illustrates system for producing a continuous liquid jet according to an embodiment of the invention.

FIG. 7 illustrates a time-elapsed sequence of a continuous liquid jet according to an embodiment of the invention.

FIG. 8 is a top cross-sectional view of the nozzle assembly producing a liquid jet and droplet stream according to the fourth aspect of the invention.

FIG. 9 is an end view of the nozzle assembly producing a liquid jet and droplet stream according to the fourth aspect of the invention.

FIG. 10 shows three images each of a detail view of the distal end of the nozzle assembly according to the fourth aspect of the invention producing a liquid jet following a boundary layer of a first side of a diverging section of a converging-diverging channel, a liquid jet following a boundary layer of a second side of a diverging section of a converging-diverging channel, and a liquid jet substantially centered between the first side and the second side of the diverging section of the converging-diverging channel.

FIG. 11 shows two images each of a detail view of the distal end of the nozzle assembly according to the fourth aspect of the invention producing a liquid jet following a boundary layer of a first side of a diverging section of a converging-diverging channel and a liquid jet following a boundary layer of a second side of a diverging section of a converging-diverging channel, as well as first and second switching channels.

A more complete understanding of the present invention may be derived by referring to the detailed description when considered in connection with the following illustrative figures. In the figures, like reference numbers refer to like elements or acts throughout the figures. Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. It should be noted that there are many different and alternative configurations, devices and technologies to which the disclosed inventions may be applied. The full scope of the inventions is not limited to the examples that are described below.

Referring to FIG. 1A and FIG. 1B, a cross-section and a perspective view of a nozzle 100 is illustrated according to an embodiment of the invention. The nozzle assembly 100 comprises: a housing 150, wherein a distal end of the housing defines an outlet channel 120; a capillary 130 disposed within the housing 150, wherein the capillary 130 comprises an optionally tapered end 131; and at least one bore 132 defined by the capillary 130, wherein the at least one bore 132 defines a capillary outlet 134.

The housing 150 is sized and shaped to receive the capillary 130. The internal cross-section of the housing may take any cross-sectional form that allows ample access for a first fluid (e.g., a gas) to have a sufficient flow rate and a substantially symmetrical flow pattern. Asymmetry in fluid flow may force the resulting filamentary liquid jet to emerge from the outlet channel off-axis. Examples of suitable forms include but are not limited to circular, square, triangular, or hexagonal. In certain embodiments, the internal cross-section of the housing is circular. In certain embodiments, the internal cross-section of the housing is square.

In the embodiment illustrated in FIGS. 1A and 1B, the internal cross-section of the housing 150 is circular, such that the housing is substantially cylindrical, and an inner diameter of the housing 150 is greater than an outer diameter of the capillary 130 such that there is a coaxial space 160 between the inner wall of the housing 170 and the external wall of the capillary 180.

The capillary 130 has at least one bore 132 through which a fluid may flow. The capillary 130 may be comprised of borosilicate, or any other material known to one in the art.

The capillary bore 132 can have a substantially constant, diverging, or converging diameter along its length. In certain embodiments, the capillary bore can have a substantially constant or diverging diameter along its length. A constant or diverging diameter can prevent particles from clogging the capillary bore 132, which may occur in a capillary bore with a constricting diameter. In certain embodiments, the capillary bore can have a substantially constant diameter along its length. In certain other embodiments, the capillary bore can have a diverging diameter along its length.

In one embodiment, a tapered end of the capillary 131 is received in the outlet channel 120. In order to aid in self-centering alignment of the capillary 130 within the housing 150, the tapered end 131 may be substantially conical. Alternatively, the tapered end 131 may be substantially conical and beveled. This has the advantage of providing two different angles to facilitate adaptability of insertion of the capillary 130 into the outlet channel 120. This embodiment can operate with a single bevel as well.

In yet another embodiment, the tapered end of the capillary 131 defines a plurality of planar flats (not shown), preferably with a minimum of at least three planar flats to achieve adequate gas flow. In certain embodiments, three to about ten planar flats are provided on the tapered end of the capillary 131. In certain embodiments, three to about eight planar flats; or three to about six planar flats are provided on the tapered end of the capillary 131. In certain embodiments, three flats; or four flats; or five flats, or six flats; or seven flats; or eight flats; or nine flats; or ten flats are provided on the capillary tube's tapered end 131.

These planar flats take the form of symmetric apertures evenly spaced and equally angled about the periphery of the tapered end 131 of the capillary through which the gas flow can merge between the tapered end 131 and housing 150, when the tapered end 131 and outlet channel 120 are mated together to achieve self-centering.

The at least one bore 132 extends along the length of the capillary 130 to the tapered end 131. In one embodiment, the at least one bore 132 comprises a single bore 132 that is substantially aligned with the central axis of the capillary 130. The term “substantially aligned” as used herein with respect to two orifices means that the vector at the center of a first orifice and normal to the plane defined by the first orifice intersects and is essentially normal (e.g., 90°+/−10°, preferably +/−5°) to the plane defined by the second orifice, and intersects the plane defined by the second orifice within the boundary of the second orifice. More preferably, the vector at the center of a first orifice and normal to the plane defined by the first orifice is essentially normal to the plane defined by the second orifice and intersects the plane defined by the second orifice essentially at the center (e.g., within 10% of the total diameter of the orifice; preferably, within 5%) of the second orifice. The single bore 132 may diverge from the central axis 130 to define the capillary outlet 134 on a side surface of the tapered end 131.

The capillary outlet 134 may protrude from the housing 150 such that the end of the capillary is situated within the continuum flow regime of the supersonic expansion of the coaxial gas. The size of this region depends on the gas species and the gas flow rate, as would be clear to one skilled in the art. For example, the end of the capillary can be within a couple of gas aperture diameters (e.g., about one to about five; or about one to about three times the diameter of the outlet channel 120) downstream of the gas aperture exit plane. The minimum distance is zero diameters downstream of the gas aperture exit plane.

In certain embodiments, the capillary outlet protrudes at least one aperture diameter from the housing. For example, the capillary outlet can protrude about 0 times to three times the aperture diameter from the housing. Without being limited to any one theory of operation, the extension of the capillary outlet beyond the housing allows the liquid jet to be extruded in free jet expansion of the gas, and prevents the continuous liquid jet from breaking into droplets.

In another embodiment, the at least one bore 132 is parallel to but spaced apart from the central axis of the capillary 130. In the case where the capillary 130 defines two (or more) bores 132, the liquid could flow through either or both of the bores 132. Alternatively, two reacting liquids could be sent separately down the respective bores 132 to be mixed at the tip of the distal end of the capillary 131.

Referring to FIG. 1C, a perspective view of an embodiment of the invention is illustrated. In this embodiment, the nozzle 190 has the cross-section of FIG. 1A. However, in this embodiment the internal cross-section of the housing 151 is substantially square-shaped. The capillary 131 is substantially the same as the capillary 131 of FIG. 1B, and the capillary outlet 134 still protrudes from the housing 151.

In one embodiment, the distal end of the capillary comprises an asperity. The asperity is a slight projection (e.g., a point or bump) from the exterior surface of the capillary. The asperity is preferably centered on the distal end of the capillary, such that the asperity is automatically centered when the capillary is inserted in the housing. When a continuous linear stream is desired, the asperity may protrude beyond the housing. In certain embodiments, the capillary outlet 134 may be upstream of the plane of the gas aperture (e.g., 120); however, the asperity should extend beyond the plane of the gas aperture.

Alternatively, the asperity may be contained within the outlet channel. The provision of an asperity has the advantageous effect of controlling the point at which the second fluid will emerge from the capillary, since the liquid jet will emerge from the most pronounced asperity present on the distal end of the capillary.

Referring to FIG. 2A and FIG. 2B, a perspective view and a cross-section view of a nozzle 200 are illustrated according to an embodiment of the invention. In the illustrated embodiment, the housing 250 defines a square internal cross-section, such that the four corners 204 of the housing provide sufficient access for gas flow. The square internal cross-section allows the capillary 230 to make contact with the housing 250, aiding in alignment, while allowing area for gas to flow. The distal end of the housing may be formed into a symmetric convergent taper to create the outlet channel 220. Alternatively, the outlet channel 220 may have a constant diameter along its length. The capillary 230 is preferably substantially aligned along the axis of the outlet channel 220. As illustrated, the capillary 230 is not tapered, however in other embodiments the capillary 230 may be tapered.

Referring to FIG. 3A and FIG. 3B, a perspective view and a cross-section view of a nozzle 300 are illustrated according to an embodiment of the invention. In the illustrated embodiment, the housing 350 defines a substantially circular internal cross-section. The capillary 230 is substantially the same as the capillary 230 in FIG. 2A and FIG. 2B. The housing 350 has an inner diameter greater than an outer diameter of the capillary 230, such that gas may flow in an area 320 between the two.

Referring to FIG. 4, the invention provides a method for producing a continuous liquid jet comprising the steps of: providing a capillary with a bore 410; injecting a liquid into a proximal end of the capillary 420; and applying a gas pressure to the liquid such that the liquid emerges from a distal end of the bore as a continuous liquid jet 430.

Referring to FIG. 5, the capillary is located within a housing similar to FIG. 1C. In this embodiment, a pressurized gas is inserted into the housing such that gas flows through the housing and exits through the outlet channel. The pressurized gas can comprise or consist essentially of an inert gas. The term “inert gas” as used herein means a gas which will not cause degradation or reaction of the fluids and/or any analytes. Such gases preferably contain limited levels of oxygen and/or water; however, the acceptable level of water and/or oxygen will depend on the fluids and/or analytes, and is readily apparent to one skilled in the art. Such atmospheres preferably include gases such as, but not limited to, hydrogen, nitrogen, carbon dioxide, helium, neon, argon, krypton, xenon, volatile hydrocarbon gases, or mixtures thereof. In certain embodiments, the inert gas comprises nitrogen, helium, argon, or a mixture thereof. In certain embodiments, the inert gas comprises nitrogen. In certain embodiments, the inert gas comprises helium. In certain embodiments, the inert gas comprises argon.

The pressurized gas can be supplied to the housing at pressures ranging from about 2 to 100 times atmospheric pressure; or about 2 to 50 times atmospheric pressure; or about 2 to 25 times atmospheric pressure; or about 2 to 15 times atmospheric pressure; or about 2 to 10 times atmospheric pressure; more preferably, at pressures ranging from about 2 to 5 times atmospheric pressure; or pressures ranging from about 3 to 5 times atmospheric pressure; or pressures ranging from about 5 to 100 times atmospheric pressure; or about 5 to 50 times atmospheric pressure; or about 5 to 25 times atmospheric pressure; or about 5 to 15 times atmospheric pressure; or about 5 to 10 times atmospheric pressure; or pressures ranging from about 9 to 100 times atmospheric pressure; or about 9 to 50 times atmospheric pressure; or about 9 to 25 times atmospheric pressure; or about 9 to 15 times atmospheric pressure.

In some embodiments the fluid comprises an analyte; such fluids preferably comprise a heterogeneous or homogeneous solution, or particulate suspension of the analyte in the second fluid. The fluid includes, but is not limited to, water and various solutions of water containing detergents, buffering agents, anticoagulants, cryoprotectants, lipids, and/or other additives as needed (e.g., sucrose) to form analyte-containing streams while maintaining the analyte in a desired molecular conformation, including crystalline forms. In certain embodiments, the fluid comprises an aqueous solution of lipids (e.g, monoolein or monopalmitolein), and optional buffering agents, in amounts and concentrations sufficient to form a lipidic cubic phase. For example, see Landau et al., Proc. Natl. Acad. Sci. 1996, 93, 14532-535, which is hereby incorporated by reference in its entirety.

Preferred analytes include, but are not limited to, proteins, protein complexes, peptides, nucleic acids (e.g., DNAs, RNAs, mRNAs), lipids, functionalized nanoparticles, viruses, bacteria, and whole cells. In certain embodiments, the analyte is a protein complex, such as, but not limited to, Photosystem I (PSI). In certain other embodiments, the fluid comprises an analyte (e.g., a protein such as PSI) and an aqueous solution of lipids (e.g, monoolein or monopalmitolein), and optional buffering agents, in amounts and concentrations sufficient to form a lipidic cubic phase.

The fluid is preferably supplied to the capillary at pressures ranging from about 2 to 35 times atmospheric pressure; more preferably, at pressures ranging from about 10 to 20 times atmospheric pressure; or pressures ranging from about 15 to 20 times atmospheric pressure.

In this embodiment, the gas exerts gas dynamic forces on the liquid stream emerging from the capillary 130, significantly reducing the diameter of the liquid stream. The liquid stream preferably emerges from the constriction as a continuous, linear, filamentary liquid jet 610 of microscopic diameter. The liquid jet 610 may be much smaller than the capillary bore 632 from which it emerges.

For example, the jet formed for the second fluid according to the methods of the invention can have a diameter of less than 20 μm. More preferably, the droplets have a diameter of less than 19 μm, 18 μm, 17 μm, or 16 μm. Even more preferably, the droplets have a diameter of less than 15 μm, 14 μm, 13 μm, 12 μm, 11 μm, 10 μm; 9 μm, 8 μm, 7 μm, 6 μm, 5 μm, 4 μm, 3 μm, 2 μm, or 1 μm, or 100 nm. In other embodiments, the droplets formed according to the methods of the invention have a diameter ranging from about 1 to 20 μm; or about 1 to 19 μm; or about 1 to 18 μm; or about 1 to 17 μm; or about 1 to 16 μm; or about 1 to 15 μm; or about 1 to 14 μm; or about 1 to 13 μm; or about 1 to 12 μm; or about 1 to 11 μm; or about 1 to 10 μm; or about 1 to 9 μm; or about 1 to 8 μm; or about 1 to 7 μm; or about 1 to 6 μm; or about 1 to 5 μm. In other embodiments, the droplets formed according to the methods of the invention have a diameter ranging from about 100 nm to 20 μm; or about 100 nm to 19 μm; or about 100 nm to 18 μm; or about 100 nm to 17 μm; or about 100 nm to 16 μm; or about 100 nm to 15 μm; or about 100 nm to 14 μm; or about 100 nm to 13 μm; or about 100 nm to 12 μm; or about 100 nm to 11 μm; or about 100 nm to 10 μm; or about 100 nm to 9 μm; or about 100 nm to 8 μm; or about 100 nm to 7 μm; or about 100 nm to 6 μm; or about 100 nm to 5 μm.

In the illustrated embodiment, the housing gas pressure is 150 psi, and the liquid is 1.4 molar sucrose solution with one atmosphere of back pressure on the liquid. The inner diameter of the capillary is 50 microns, and the continuous liquid jet 610 narrows to a diameter of 15 microns.

In one embodiment, the method further comprises applying a gas back pressure on the liquid. Certain fluids with high viscosity, such as lipidic cubic phase (LCP) (˜500 Pa-s) or 1.4 M sucrose in water solution (0.081 Pa-s at 25° C.) can be inserted into the nozzle and result in a microscopic linear liquid jet. Many other fluids are capable of resulting in microscopic linear liquid jets as well. The gas back pressure assists in transmitting viscous liquids through the capillary bore that otherwise may have been incapable of extrusion.

“High viscosity” as used herein means significantly higher than the viscosity of water (1.00 centipoise at 20° C.) (e.g, oils such as olive oil (84 centipoise) and castor oil (986 cp) would be considered high viscosities). For laminar flow through a tube (Poiseuille flow), the volumetric flow rate is inversely proportional to the fluid viscosity, directly proportional to the pressure drop per unit length along the tube, and varies with the fourth power of the tube radius. Accordingly for a given pressure applied front-to-back along the tube, the volumetric flow rate decreases with increasing viscosity, and dramatically so as the tube radius is decreased. It is therefore the tube diameter and the required pressure that set an effective upper limit on the viscosity that can be accommodated.

When the nozzle is placed in a vacuum, the liquid jet is subject to free-jet expansion of the gas. This allows the liquid to be extruded in a microscopic continuous stream, delaying the break-up into droplets.

The gas back pressure may be applied in a variety of ways. For example, in one embodiment, high pressure tubing is coupled to a reservoir for the liquid, which is coupled to the capillary. The liquid may be inserted into the reservoir with a syringe, or before assembly, or by any other method known to one in the art. A gas pressure can be applied into the high pressure tubing by methods familiar to those skilled in the art. The gas pressure may be applied in the range of about 600 psi to about 2000 psi. In one embodiment dry nitrogen gas is applied in the range of 600 to 2000 psi. Other sources of gas pressure are well known and may be used. Higher or lower pressures may be applied depending on the material used for the fluid and the desired flow rate. Depending on the pressure applied, flow rates may be from about 1 nL/min to about 10 μL/min; however, higher and lower flow rates may be possible. In certain embodiments, the flow rate can be less that about 100 nanoliters/minute.

In other embodiments, lower gas pressures may be used, ranging from about 1 atm to about 100 atm. For example, 1 atm of pressure may be used to extrude 1.4M sucrose in water solution in a linear continuous stream.

Referring to FIG. 6, an apparatus for extruding a liquid is illustrated according to an embodiment of the invention. In this embodiment, the apparatus comprises a capillary with a 30 micron capillary bore, polyethyl ethyl ketone (PEEK) tubing to supply pressure up to 2000 psi, and a liquid reservoir.

Referring to FIG. 7, a series of photographs of liquid being extruded is illustrated according to an embodiment of the invention. In this embodiment, the liquid is LCP (having a viscocity of about 1,820,000 cp at 25° C.), and the capillary bore has a diameter of 30 microns. The LCP is subject to a gas back pressure of 1500 psi, and there is no housing gas pressure. The extruded LCP stream has a diameter of 30 microns. Because there is no housing gas pressure, the continuous liquid stream has a diameter equivalent to that of the capillary bore, and the continuous liquid stream curls after it exits the capillary. A housing gas pressure can maintain a substantially straight continuous liquid stream due to the forces on the stream.

In another aspect, the invention provides injectors comprising (i) a chamber comprising a vacuum orifice and an injector orifice, wherein the chamber is adapted for use with a vacuum analysis system; and (ii) a nozzle as described above, wherein the outlet channel of the nozzle outputs to the chamber and is essentially aligned with the injector orifice.

The term “essentially aligned” as used herein with respect to two orifices means that the vector at the center of a first orifice and normal to the plane defined by the first orifice intersects and is essentially normal (e.g., 90°+/−10°, preferably +/−5°) to the plane defined by the second orifice, and intersects the plane defined by the second orifice within the boundary of the second orifice. More preferably, the vector at the center of a first orifice and normal to the plane defined by the first orifice is essentially normal to the plane defined by the second orifice and intersects the plane defined by the second orifice essentially at the center (e.g., within 10% of the total diameter of the orifice; preferably, within 5%) of the second orifice.

In operating the injector of the invention, a vacuum is maintained in the chamber via the vacuum orifice and a liquid jet is provided by the nozzle as discussed previously. Preferably, the vacuum in the injector is maintained at a level less than or equal to the vacuum maintained within the vacuum analysis system.

The injector allows for the liquid jet to be injected into a vacuum analysis system. Such systems may involve samples analyzed under pressures ranging from ultra-high vacuum (UHV) or high vacuum (HV) up to one atmosphere (e.g., environmental scanning electron microscopy (e-SEM) or environmental tunneling electron microscopy (e-TEM)). For example, the samples may be analyzed under pressures ranging from about 100 torr to about 10⁻⁹ mbar. In certain embodiments, the samples are analyzed under pressures suitable for environmental imaging methods, such as, but not limited to, pressures ranging from about 0.1 torr to 100 torr, or 0.1 torr to 10 torr, or 0.1 mbar to 1 torr.

In an embodiment of the invention, the injector of the invention further comprises a vacuum pump for providing a vacuum in the first chamber via the vacuum orifice.

In a preferred embodiment, the injector orifice comprises a simple aperture. In another preferred embodiment of the third aspect, the injector orifice comprises a tube. In a more preferred embodiment of the third aspect, the injector orifice further comprises a molecular beam skimmer.

The injector of the invention may further comprise an aligner for aligning the outlet channel of the nozzle with the injector orifice. Such aligners include mechanical alignment, such as via thumbscrews, or mechano-piezoelectric devices, such as precision mechanical drives or precision piezoelectric drives that move the capillary laterally and axially with respect to the injector orifice. The aligner may be sealed within the assembly which comprises the injector of the invention and/or pass-through vacuum seals, so that the only physical communication between the nozzle and the surrounding plenum is via the nozzle exit orifice and the only physical communication between the plenum and the surrounding ambient is via the injector orifice.

In a fourth aspect, shown in FIGS. 8-11, for example, the invention provides a nozzle assembly comprising, (a) a housing 800, wherein the housing 800 defines a cavity enclosed on all sides with an inlet opening 805 at a proximal end and a de Laval Nozzle 810 at a distal end, wherein the de Laval Nozzle 810 defines a converging-diverging channel, and wherein a housing outlet 815 is defined within the de Laval Nozzle 810 at the point where the converging-diverging channel is constricted, (b) a capillary tube 820 disposed within the cavity of the housing such that there is a coaxial space 825 maintained between a portion of the capillary 820 and a portion of the housing 800, wherein a distal end 830 of the capillary 820 is optionally tapered, (c) at least one bore 835 defined by the capillary 820, wherein a proximal end of the at least one bore defines a capillary inlet 840 and a distal end of the at least one bore defines a capillary outlet 845, wherein the capillary outlet 845 does not extend beyond the housing outlet 815, and (d) wherein the housing 800 further defines a first propelling channel 850 and a second propelling channel 855, wherein the first and the second propelling channels 850, 855 are each disposed substantially perpendicular to the coaxial space 825 and are in fluid communication with the coaxial space 825.

As used herein, a “de Laval Nozzle” means a convergent-divergent channel in the shape of an asymmetric hourglass. The de Laval Nozzle is used to accelerate first and second fluids passing through the constriction defining the housing outlet 815, where the nozzle transitions from converging to diverging. Thus, in a preferred embodiment, the capillary outlet 845 remains proximal of the housing outlet 815 to obtain the maximum benefits of the acceleration of fluid through the nozzle constriction. In one embodiment, the housing outlet 815 has a rectangular cross-section, shown in FIG. 9.

As used herein, a “coaxial space” means that a substantially uniform separation is maintained between a portion of the housing and a portion of the outer surface of the capillary tube.

In one embodiment of the fourth aspect, the first propelling channel 850 and the second propelling channel 855 are disposed on opposing sides of the housing 800, as shown in FIG. 8. A fluid is injected into the first and the second propelling channels 850, 855, flows into the coaxial space 825 and then out through the housing outlet 815 into the divergent section 811 of the converging-diverging channel 810. As such, one benefit of arranging the first and second propelling channels 850, 855 on opposing sides of the housing 800 is even fluid distribution within the coaxial space 825.

In one embodiment of the fourth aspect, shown in FIG. 11, the invention further provides a first switching channel 860 defined in the housing 800 on a first side 865 of a diverging section 811 of the converging-diverging channel 810 and a second switching channel 870 defined in the housing 800 on the second side 875 of the diverging section 811 of the converging-diverging channel 810, wherein the first and second switching channels 860, 870 are each in fluid communication with the diverging section 811 of the converging-diverging channel 810. As explained below, in operation, when the liquid jet 880 is flowing along the boundary layer 865 of the side of the diverging section in which a switching channel 860 is disposed, that switching channel 860 directs a discrete puff of air into the liquid jet 880. The puff of air disturbs the boundary layer and causes the liquid jet 880 to switch to the boundary layer 875 on the opposite side of the diverging section 811. The liquid jet 880 can then be sent back to the original boundary layer 860 through a second discrete puff of air directed through the other switching channel 870, which is now adjacent the liquid jet 880. The ability to switch the flow from one boundary layer to the other provides a way to conserve the fluids by delivering the liquid jet 880 only during an X-ray pulse, discussed in more detail below.

In a fifth aspect, the invention provides a method for producing a liquid jet 880 comprising (a) providing a nozzle assembly according to the fourth aspect of the invention, (b) injecting a first fluid into the first and second channels 850, 855, and (c) injecting a second fluid into the capillary inlet 840. In one embodiment, the first fluid is helium gas.

As used herein, a “liquid jet” ranges from a substantially constant stream of fluid 880 to a single-file steam of droplets 885.

In one embodiment, the foregoing method further comprises operating at subsonic flow by maintaining an upstream-to-downstream pressure ratio in a converging-diverging channel 810 in the range of about 1.03 to about 1.89. As used herein, “upstream” refers to the pressure maintained in the converging section of the de Laval Nozzle 810 and “downstream” refers to the pressure maintained in the diverging section 811 of the de Laval Nozzle 810. The pressure in the converging section and diverging sections can be calculated based on the geometry of the de Laval Nozzle 810 and the pressure at which liquid is injected into the first and second propelling channels 850, 855.

In another embodiment, shown in FIG. 10, the method further comprises (a) producing a liquid jet 880, 885 following a boundary layer of a first side 865 of a diverging section of a converging-diverging channel 810, (b) injecting a first puff of air into a first switching channel 860, and (c) in response to the first puff of air, switching the liquid jet 880, 885 to a boundary layer of a second side 875 of the diverging section 811 of the converging-diverging channel 810. In an additional embodiment, shown in FIG. 10, the method further comprises (a) injecting a second puff of air into a second switching channel 870 and (b) in response to the second puff of air, switching the liquid jet 880, 885 to the boundary layer of the first side 865 of the diverging section 811 of the converging-diverging channel 810. Both of the foregoing embodiments are achieved when the diverging section 811 of the converging-diverging channel 810 is maintained at atmospheric pressure.

In still another embodiment, shown in FIG. 10, the method further comprises (a) operating the diverging section 811 of the converging-diverging channel 810 under vacuum and (b) in response to operating under vacuum, producing a liquid jet 880, 885 substantially centered between the first side 865 and the second side 875 of the diverging section 811 of the converging-diverging channel 810.

In an additional embodiment, the method further comprises directing the liquid jet 880 across a pulsed X-ray beam. Here, a very powerful X-ray source, such as the Linac Coherent Light Source, for example, is utilized with a femtosecond pulse duration while a liquid jet 880 under vacuum is directed across the path of the X-ray, to conduct experiments capturing results utilizing crystallography.

In a sixth aspect, the invention provides a method for manufacturing the housing of the nozzle assembly of the fourth aspect, comprising, (a) soft-baking photoresist that is spin-coated in a desired pattern on a silicon wafer, (b) exposing the photoresist to UV light through a photomask, (c) chemically developing the photoresist, (d) hard-baking the photoresist to form a negative stamp, (e) pouring uncured poly(dimethylsiloxane) into the negative stamp to create a layer 890 defining a cavity and a plurality of microchannels, and (f) fixing the layer between a top slab 891 and a bottom slab 892 of poly(methyl methacrylate), as shown for example in FIG. 9.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. The above embodiments and other embodiments may be combined as is apparent to those of skill in the art upon studying the above description, unless noted otherwise. For example, the second aspect could be combined with the first or the fourth aspects. Likewise, the sixth aspect could be combined with the first or the fourth aspects. The scope of the present invention includes any other applications in which embodiment of the above structures and fabrication methods are used. The scope of the embodiments of the present invention should be determined with reference to claims associated with these embodiments, along with the full scope of equivalents to which such claims are entitled.

We claim:

1. A nozzle assembly comprising:
a housing, wherein a distal end of the housing defines an outlet channel;
a capillary disposed within the housing, wherein a distal end of the capillary is optionally tapered; and
at least one bore defined by the capillary, wherein the at least one bore defines a capillary outlet at the distal end of the capillary, and wherein the capillary outlet is located outside the outlet channel.

2. The nozzle assembly of claim 1, wherein the capillary is substantially aligned along an axis of the outlet channel.

3. The nozzle assembly of claim 1, wherein the at least one bore comprises a single bore aligned with a central axis of the capillary.

4. The nozzle assembly of claim 3, wherein the single bore diverges from the central axis of the capillary.

5. The nozzle assembly of claim 1, wherein the at least one bore is parallel to but spaced apart from a central axis of the capillary.

6. The nozzle assembly of claim 1, wherein the tapered end of the capillary is substantially conical.

7. The nozzle assembly of claim 1, wherein the capillary is comprised of borosilicate.

8. The nozzle assembly of claim 1, wherein the tapered end of the capillary defines a plurality of planar flats.

9. The nozzle assembly of claim 1, wherein the tapered end of the capillary is received in the outlet channel.

10. The nozzle assembly of claim 1, wherein an inner diameter of the housing is greater than an outer diameter of the capillary such that there is a coaxial space between the inner wall of the housing and the external wall of the capillary.

11. The nozzle assembly of claim 1, wherein the housing defines a substantially square internal cross-section.

12. The nozzle assembly of claim 1, wherein the capillary comprises an asperity.

13. The nozzle assembly of claim 1, further comprising a device configured to apply gas pressure to the at least one bore.

14. A system for producing a continuous liquid jet comprising:
a capillary having a bore and a capillary outlet;
a liquid reservoir coupled to the bore; and
a gas pressure source coupled to the liquid reservoir.

15. The system of claim 14 further comprising a housing with an interior volume and an exit channel, wherein the capillary is located within the interior volume of the housing.

16. The system of claim 15 wherein the capillary extends beyond the exit channel.

17. A method for producing a continuous liquid jet comprising:
providing a capillary tube with a bore;
injecting a liquid into a proximal end of the bore;
applying a pressure to the liquid such that the liquid emerges from a distal end of the bore as a continuous liquid jet.

18. The method of claim 17, further comprising placing the distal end of the bore in a vacuum.

19. The method of claim 17, further comprising providing a housing with an outlet channel and inserting the capillary into the housing.

20. The method of claim 19, further comprising inserting a pressurized gas into a proximal end of the housing that exits through the outlet channel.

21. The method of claim 17, wherein the liquid comprises lipidic cubic phase.

22. The method of claim 17, wherein the liquid comprises a sucrose-water solution.

23. The method of claim 17, wherein the continuous liquid jet has a diameter of less than about 50 microns.

24. An injector comprising:
(i) a chamber comprising a vacuum orifice and an injector orifice, wherein the chamber is adapted for use with a vacuum analysis system; and
(ii) a nozzle according to claim 1, wherein the outlet channel of the nozzle outputs to the chamber and is essentially aligned with the injector orifice.

25. (canceled)

26. A nozzle assembly comprising:
a housing, wherein the housing defines a cavity enclosed on all sides with an inlet opening at a proximal end and a de Laval Nozzle at a distal end, wherein the de Laval Nozzle defines a converging-diverging channel, and wherein a housing outlet is defined within the de Laval Nozzle at the point where the converging-diverging channel is constricted;
a capillary disposed within the cavity of the housing such that there is a coaxial space maintained between the capillary and the housing, wherein a distal end of the capillary is optionally tapered;
at least one bore defined by the capillary tube, wherein a proximal end of the at least one bore defines a capillary inlet and a distal end of the at least one bore defines a capillary outlet, wherein the capillary outlet does not extend beyond the housing outlet; and
wherein the housing further defines a first propelling channel and a second propelling channel, wherein the first and second propelling channels are each disposed substantially perpendicular to the coaxial space and are in fluid communication with the coaxial space.

27.-28. (canceled)

29. The nozzle assembly of claim 26, further comprising:
a first switching channel defined in the housing on a first side of a diverging section of the converging-diverging channel and a second switching channel defined in the housing on the second side of the diverging section of the converging-diverging channel, wherein the first and second switching channels are each in fluid communication with the diverging section of the converging-diverging channel.

30. A method for producing a liquid jet comprising:
providing a nozzle assembly according to claim 26;
injecting a first fluid into the first and the second propelling channels; and
injecting a second fluid into the capillary inlet.

31.-37. (canceled)

38. A method for manufacturing the housing of claim 26, comprising:
soft-baking photoresist that is spin-coated in a desired pattern on a silicon wafer;
exposing the photoresist to UV light through a photomask;
chemically developing the photoresist;
hard-baking the photoresist to form a negative stamp;
pouring uncured poly(dimethylsiloxane) into the negative stamp to create a layer defining a cavity and a plurality of microchannels; and
fixing the layer between a top slab and a bottom slab of poly(methyl methacrylate).
